(19) United States
(12) Patent Application Publication
(10) Pub. No.: US 2013/0254194 A1
(43) Pub. Date: Sep. 26, 2013

(54) PROVIDING SETTING RECOMMENDATIONS TO A COMMUNICATION DEVICE

(71) Applicants: Naomi HADATSUKI, San Jose, CA (US); Hideaki TANIOKA, San Jose, CA (US)

(72) Inventors: Naomi HADATSUKI, San Jose, CA (US); Hideaki TANIOKA, San Jose, CA (US)

(73) Assignee: FUJITSU LIMITED, Kawasaki-shi (JP)

(21) Appl. No.: 13/429,197

(22) Filed: Mar. 23, 2012

(51) Int. Cl. G06F 17/30

(52) U.S. Cl. 707/736; 707/E17.032

(57) ABSTRACT

According to an aspect of an embodiment, a method to effect setting recommendations at a communication device is described. The method may include receiving contextual data at the communication device. The contextual data may indicate conditions existing at application of a setting during use of an application at the communication device. The method may further include identifying a pattern based on the contextual data. The method may further include generating, based on the identified pattern, a setting recommendation to apply during use of the application at the communication device under conditions substantially matching the identified pattern. The method may further include presenting the setting recommendation to a user of the communication device and receiving data indicating a response to the setting recommendation.

### FIELD

Example embodiments discussed herein are related to providing setting recommendations to a communication device.

### BACKGROUND

Settings of an application of a communication device may typically be done manually by a user of the communication device. The setting may apply at all times regardless of the environmental context under which the application is being used. For example, the user may manually set a brightness setting of an application to a setting suitable for certain light conditions. The brightness setting may be fixed until such time as the user manually changes the setting. Thus at a different time and/or under different light conditions where the brightness setting may be unsuitable in view of the different conditions, the user may have to manually adjust the brightness setting.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method to recommend setting adjustments to be applied to an application of a communication device is described. The method may include receiving contextual data at the communication device. The contextual data may indicate conditions existing at application of a setting during use of an application at the communication device. The method may further include identifying a pattern based on the contextual data. The method may further include generating, based on the identified pattern, a setting recommendation of a setting to apply during use of the application at the communication device under conditions substantially matching the identified pattern. The method may further include presenting the setting recommendation to a user of the communication device and receiving data indicating a response to the setting recommendation.

The object and advantages of the embodiments will be realized and achieved by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example operating environment in which a setting recommendation to a communication device may be implemented;

FIG. 2 is block diagram of an example embodiment of a communication device that may be implemented in the operating environment of FIG. 1;

FIG. 3 is a flowchart of an example method of generating a setting recommendation to be applied to a communication device;

FIG. 4 is a block diagram of an example embodiment of a computing device that may be implemented to generate and/or apply setting recommendations, all arranged in accordance with at least some of the embodiments described herein.

### DESCRIPTION OF EMBODIMENTS

According to some embodiments described herein, setting recommendations for a communication device may be presented to a user. Such setting recommendations may allow the user to avoid the inconvenience of initiating manual changes to a setting for an application at a communication device. Setting recommendations may be based on a pattern which, in turn, is based on contextual data indicating conditions existing at application of a first setting during use of an application at the communication device. Contextual data may include environmental attributes such as time of day, ambient lighting, ambient sound, location, and the like. The pattern may also incorporate a response by the user to the setting recommendation.

For example, the user of the communication device may prefer a “portrait and locked” setting for an electronic book (e-book) application at the communication device at night in the user's bedroom. A pattern may be identified based on the time of day, ambient lighting, and/or the location to generate a setting recommendation based on the identified pattern. For instance, the setting recommendation may be to apply the “portrait and locked” setting for the application in the future under conditions that match or substantially match the identified pattern. When the user initiates the application at some future time and/or under conditions that match or substantially match the identified pattern, the setting recommendation may be presented to the user through a user interface of the communication device. The user may respond by accepting or rejecting the setting recommendation and the response may be used along with the contextual data in identifying the pattern further.

Alternately or additionally, the application at the communication device may be a first application. The setting recommendation may be presented to the user at initiation of a second application identified as substantially similar to the first application. For example, the setting recommendation may be based on a pattern identified at a first e-book application. The user may initiate a second e-book application identified as substantially similar to the first e-book application. The setting recommendation may be generated and presented to the user to apply the “portrait and locked” setting to the second e-book application.

Alternately or additionally, the communication device may be a first communication device and the second application may be located at a second communication device. The setting recommendation may be presented to the user at initiation of the second application at the second communication device. For example, the first application may be a first e-book application at the first communication device such as a tablet computer. The setting recommendation may be generated to apply at a second e-book reader at the second communication device such as a smartphone. The setting recommendation of “portrait and locked” may be presented to the user at initiation of the second e-book application at the second communication device.

According to some embodiments described herein, generating setting recommendations at a communication device may be facilitated by local hardware and/or local software of the communication device. Alternately or additionally, implementing setting recommendations at a communication device may be facilitated by a cloud computing system in cooperation with an application at the communication device. In these and other embodiments, setting recommendations may be generated based on the identified pattern based on contextual data including environmental attributes, as well as data indicating application attributes, and data indicating a user's response to the setting recommendation.

Embodiments of the present invention will be explained with reference to the accompanying drawings.

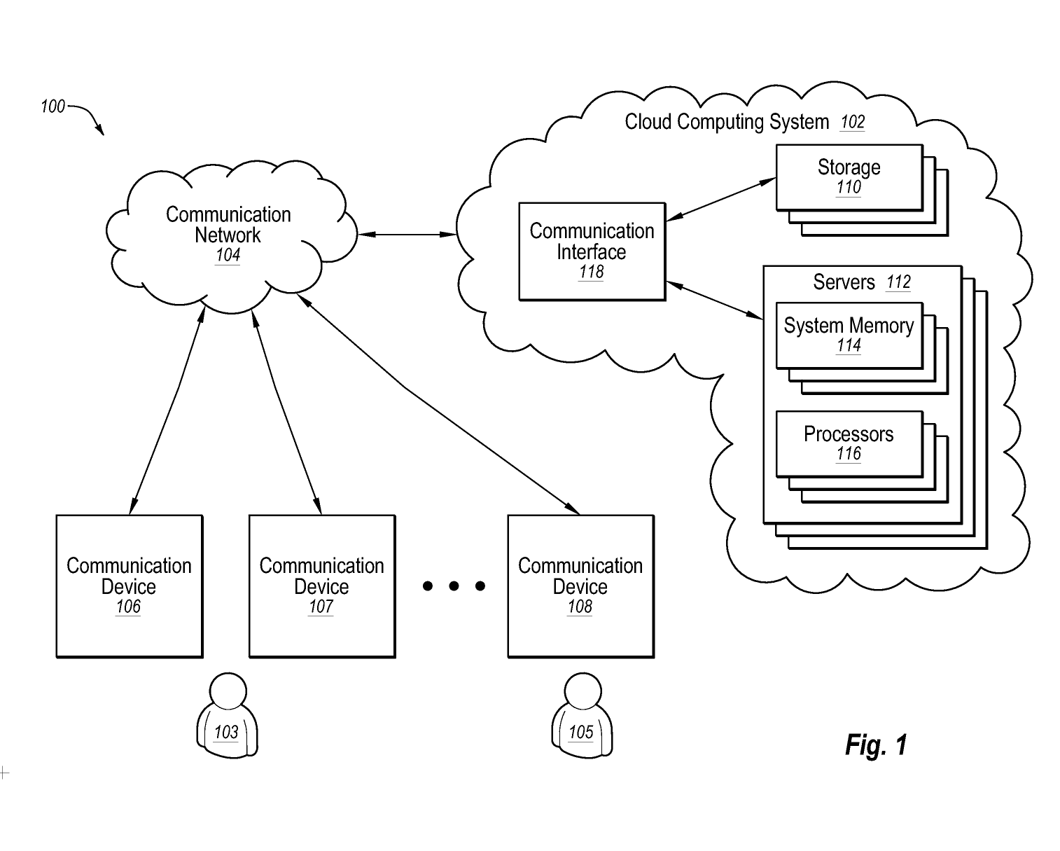

FIG. 1 illustrates an example operating environment 100 in which setting recommendations for an application at a communication device may be implemented, arranged in accordance with at least some embodiments described herein. The operating environment 100 may include a cloud computing system 102, a communication network 104, one or more communication devices 106, 107, 108, and one or more users 103, 105 associated with the one or more communication devices 106, 107, 108.

In general, the communication network 104 may include one or more wide area networks (WANs) and/or local area networks (LANs) that enable the cloud computing system 102 and the communication devices 106, 107, 108 to communicate with each other. In some embodiments, the communication network 104 includes the Internet, including a global internetwork formed by logical and physical connections between multiple WANs and/or LANs. Alternately or additionally, the communication network 104 may include one or more cellular RF networks and/or one or more wired and/or wireless networks such as, but not limited to, 802.xx networks, Bluetooth access points, wireless access points, IP-based networks, or the like. The communication network 104 may also include servers that enable one type of network to interface with another type of network.

Each of the communication devices 106, 107, 108 may include, but is not limited to: a mobile phone, a smartphone, a personal digital assistant (PDA), a personal music device such as an .mp3 player, a pager, an electronic book reader, or a tablet computer. Each of the communication devices 106, 107, 108 may further include one or more applications such as an e-book application or reader, an internet browser, a media player, and the like. Moreover, each of the communication devices 106, 107, 108 may include one or more sensors including, but not limited to: a photovoltaic sensor; an auditory sensor; a location sensor; a proximity sensor; an accelerometer; or a clock. In some embodiments, the communication devices 106, 107, 108 may also include communication interfaces, discussed in more detail below, to allow access to services provided by the cloud computing system 102. For example, each of the communication devices 106, 107, 108 may use a corresponding communication interface to provide contextual data to the cloud computing system 102. The cloud computing system 102 may receive the contextual data from the one or more communication devices 106, 107, 108, and provide setting recommendations to the one or more communication devices 106, 107, 108.

The cloud computing system 102 may include one or more hardware systems. Examples of such hardware systems may include, but are not limited to, one or more storage devices 110 and one or more servers 112. Each of the one or more servers 112 may include one or more system memory devices 114 and one or more processors 116. The cloud computing system 102 may additionally include a communication interface 118.

The storage devices 110 may include non-volatile storage such as magnetic storage, optical storage, solid state storage, or the like or any combination thereof. The storage devices 110 may be communicatively coupled to the communication interface 118.

As previously mentioned, the servers 112 may each include one or more system memory devices 114 and/or one or more processors 116 and may be configured to execute software to run and/or provide access to the cloud computing system 102, and/or to execute software that may be available in the cloud computing system 102 to the one or more communication devices 106, 107, 108.

The system memory devices 114 may include volatile storage such as random access memory (RAM). The system memory devices 114 may have loaded therein programs and/or software that may be executed by the one or more processors 116 to perform one or more of the operations described herein, such as generating setting recommendations to apply during use of an application at the communication device 106.

The communication interface 118 of the cloud computing system 102 may be configured to receive contextual data from any of the communication devices 106, 107, 108 and/or to send setting recommendations to any of the communication devices 106, 107, 108. The communication interface 118 may include, for example, a network interface card, a network adapter, a LAN adapter, or other suitable communication interface.

As already mentioned, the cloud computing system 102 may receive contextual data from one or more of the communication devices 106, 107, 108. The contextual data received at the cloud computing system 102 may include sensor data collected at one or more of the communication devices 106, 107, 108 indicating the conditions existing at the application of a setting during use of an application at the one or more communication devices 106, 107, 108. The contextual data received at the cloud computing system 102 may alternately or additionally include usage data collected at one or more of the communication devices 106, 107, 108 identifying the application in use during application of the setting.

The cloud computing system 102 may store the contextual data at the storage device 110 coupled to the communication interface 118.

The processor 116 of the cloud computing system 102 may be configured to identify a pattern based on the contextual data provided from a communication device, such as the communication device 106. The processor 116 may be further configured to generate, based on the identified pattern, a setting recommendation of a setting to apply during use of the application at the communication device 106 under conditions substantially matching the identified pattern. The processor 116 may provide the setting recommendation to the communication interface 118.

The communication interface 118 may be configured to provide the setting recommendation to the communication device 106 for presentation to a user, such as the user 103, of the communication device 106. The communication interface 118 may also be configured to receive, from the communication device 106, data indicating a response to the setting recommendation.

For example, the setting may be a user-applied brightness setting of an e-book application of the communication device 106. The user 103 may prefer a relatively low brightness setting for the e-book application when the application is being used at night in the user's bedroom. The contextual data may include the time of day, the level of ambient lighting, and/or the location of the communication device 106. The processor 116 may identify a pattern based on the contextual data and may, based on the identified pattern, generate a setting recommendation of a brightness setting to apply during use of the e-book application at the communication device 106 under conditions substantially matching the pattern. For example, the identified pattern may include a time of day (e.g., evening or night), a level of ambient lighting corresponding to the user's bedroom at the time of day, the location of the user's bedroom, and/or the particular e-book application.

The communication interface 118 may provide the setting recommendation to the communication device 106 for presentation to the user 103 of the communication device 106. For instance, the communication device 106 may query, via a graphical user interface (GUI) or other user interface (UI) of the communication device 106, if the user 103 would like to apply the setting identified in the setting recommendation to the communication device 106, and/or the setting recommendation may specify the pattern or conditions under which the recommended setting may apply. In response, the user 103 may select, via the GUI or other UI, a “Yes,” “No,” or “Never Ask Again” button, or the like. The communication interface 118 may also receive, from the communication device 106, data indicating a response to the setting recommendation.

In some embodiments, the processor 116 may be configured to confirm or adjust the identified pattern, based on the data indicating a response, in relation to the application at the communication device 103. For example, the processor 116 may identify a pattern indicating the user 103 prefers a “portrait and locked” setting for an e-book application during use of the application at night and in the user 103's bedroom. The setting recommendation may present to the user 103 the “portrait and locked” setting recommendation at night in the user 103's living room, and/or at a different time, under different ambient lighting and/or in a different location. The user 103 may respond “Yes” or “No,” for example, to the “portrait and locked” setting recommendation depending on the user 103's preference. The processor 116 may adjust the identified pattern to include or exclude the living room and/or the different time, under different ambient lighting and/or in the different location, depending on the user 103's response, for example.

In some embodiments, the application at the communication device 106 may be a first application, and a second application may be identified as substantially similar to the first application. In these and other embodiments, the processor 116 may be further configured to provide, via the communication interface 118, the setting recommendation to the communication device 106 for presentation to the user 103 of the communication device 106 to apply during use of the second application. The data indicating the response to the setting recommendation may be used by the processor 116 to update the pattern in relation to the second application.

For example, the e-book application at the communication device 106 may be a first application, and a second e-book application may be identified as substantially similar to the first e-book application. The processor 116 may provide, via the communication interface 118, the brightness setting recommendation to the communication device 106 for presentation to the user 103 of the communication device 106 to apply during use of the second e-book application. The communication interface 118 may receive, from the communication device 106, data indicating a response to the brightness setting recommendation. The data indicating the response to the setting recommendation may be used by the processor 116 to confirm or adjust the pattern in relation to the second e-book application.

Alternately or additionally, the second application may be identified as substantially similar by comparing attributes of the first application to attributes of the second application to identify any shared attributes. The attributes may include one or more of: type of content available on the first or second application, functional capabilities of the first or second application, or settings available on the first or second application, or the like or any combination thereof.

For example, the second e-book application may be identified as substantially similar by comparing attributes of the first e-book application to attributes of the second e-book application to identify any shared attributes. The attributes may include similar e-book content available on the first and second e-book application, for example.

Alternately or additionally, the communication device 106 may be a first communication device, and the second application may be located on a second communication device associated with the user 103, such as the communication device 107. The second application on the communication device 107 may be the same as or different from the first application on the communication device 106. The processor 116 may be configured to generate, based on the identified pattern, a setting recommendation of a setting to apply to the second application at the second communication device 107. The processor 116 may be configured to provide the setting recommendation to the communication interface 118. The communication interface 118 may be configured to provide the setting recommendation to the communication device 107 for presentation to the user 103 of the second communication device 107 to apply during use of the second application. The communication interface 118 may receive, from the communication device 107, data indicating a response to the setting recommendation which may be used by the processor 116 to confirm or adjust the pattern.

For example, the second e-book application may be located on the second communication device 107 relative to the first communication device 106. The processor 116 may be configured to generate, based on the identified pattern, a setting recommendation to apply during use of the second e-book application at the second communication device 107. The processor 116 may provide the brightness setting recommendation to the communication interface 118. The communication interface 118 may provide the brightness setting recommendation to the communication device 107 for presentation to the user 103 to apply during use of the second e-book application. The communication interface 118 may receive a response to the brightness setting recommendation which may be used by the processor 116 to confirm or adjust the pattern.

By utilizing the cloud computing system 102, setting recommendations presented to one or more of the communication devices 106, 107, 108 may be processed at the cloud computing system 102. Thus, processing and/or other operations may be performed at the cloud computing system 102 in some embodiments.

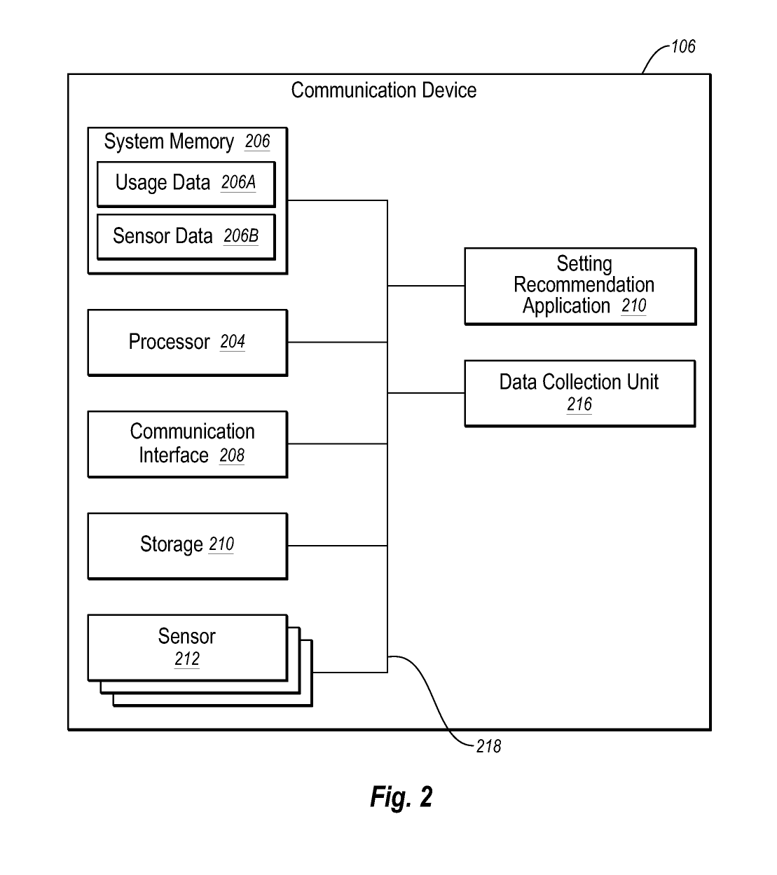

FIG. 2 is a block diagram of an embodiment of the communication device 106 of FIG. 1, arranged in accordance with at least some embodiments described herein. One or more of the communication device 107 and the communication device 108 may be similarly configured. The communication device 106 may include a processor 204 or other processing device, a system memory device 206, a communication interface 208, a storage device 210, one or more sensors 212, a setting recommendation application 214, a data collection unit 216 configured to receive contextual data, and a communication bus 218 configured to communicably couple the foregoing components together.

The processor 204 may be configured to perform one or more of the operations described herein, such as generating a setting recommendation as discussed in more detail below.

The system memory device 206 may include programs and/or software loaded therein that may be executed by the processor 204 to facilitate generation of a setting recommendation. Alternately or additionally, contextual data such as usage data 206A, sensor data 206B, and/or other data may be loaded to the system memory device 206 during execution of the programs and/or software.

The communication interface 208 of the communication device 106 may be configured to provide contextual data to the cloud computing system 102 of FIG. 1, and/or may be otherwise configured to facilitate communication with the cloud computing system 102 and/or other communication devices 107, 108. Similar to the communication interface 118 of the cloud computing system 102 of FIG. 1, the communication interface 208 may include, for example, a network interface card, a network adapter, a LAN adapter, or other suitable communication interface.

The storage device 210 may include non-volatile storage such as magnetic storage, optical storage, solid state storage, or the like or any combination thereof.

The one or more sensors 212 may include, for example: a photovoltaic sensor; an auditory sensor; a location sensor; a proximity sensor; an accelerometer; and a clock.

The setting recommendation application 214 may include software, such as computer-readable instructions stored in the storage device 210 and/or loaded in the memory 206, that is executable by the processor 204 to generate and present a setting recommendation.

The data collection unit 216 may be configured to receive contextual data generated at the communication device 106 by, e.g., the sensors 212. The data collection unit 216 may be included in the system memory device 206, for example. The contextual data may indicate conditions existing at application of a setting during use of an application at the communication device 106.

The contextual data may include sensor data 206B, e.g., from the sensors 212, indicating conditions existing at the communication device 106 at application of the setting during use of an application at the communication device 106. The contextual data may alternately or additionally include usage data 206A identifying the application in use during application of the setting. The data collection unit 216 may provide the contextual data to the processor 204.

The processor 204 may be configured to identify a pattern based on the contextual data. The processor 204 may be further configured to generate, based on the identified pattern, a setting recommendation of a setting to apply during use of the application at the communication device 106 under conditions substantially matching the identified pattern. The processor 204 may be configured to present the setting recommendation to the user 103 of the communication device 106. The processor 204 may also be configured to receive data indicating a response to the setting recommendation.

For example, the setting may be a predetermined brightness setting related to the brightness of an e-book application of the communication device 106. The user 103 may prefer a relatively low brightness setting for the e-book application when the application is being used at night in the user's bedroom. The contextual data may include the time of day, the level of ambient lighting, and the location of the communication device 106 as gathered by the one or more sensors 212. The processor 204 may identify a pattern based on the contextual data and may, based on the identified pattern, generate a setting recommendation of a brightness to apply during use of the e-book application at the communication device 106 under conditions substantially matching the pattern. For example, the identified pattern may include a time of day (e.g., evening or night), a level of ambient lighting corresponding to the user's bedroom at the time of day, the location of the user's bedroom, and/or the particular e-book application.

The processor 204 may present the setting recommendation at the communication device 106 to the user 103 of the communication device 106. For instance, the processor 204 may query, via a GUI or other UI of the communication device 106, if the user 103 would like to apply the setting identified in the setting recommendation to the communication device 106, and/or the setting recommendation may specify the pattern or conditions under which the recommended setting may apply. In response, the user 103 may select, via the GUI or other UI, a “Yes,” “No,” or “Never Ask Again” button, or the like. The processor 204 may also receive data indicating a response to the setting recommendation.

In some embodiments, the processor 204 may be configured to confirm or adjust the identified pattern, based on the data indicating a response, in relation to the application at the communication device 103. For example, the processor 204 may identify a pattern indicating the user 103 prefers a “portrait and locked” setting for an e-book application during use of the application at night and in the user 103's bedroom. The setting recommendation may present to the user 103 the “portrait and locked” setting recommendation at night in the user 103's living room, and/or at a different time, under different ambient lighting and/or in a different location. The user 103 may respond “Yes” or “No” to the “portrait and locked” setting recommendation depending on the user 103's preference. The processor 204 may adjust the identified pattern to include or exclude the living room and/or the different time, under different ambient lighting and/or in the different location, depending on the user 103's response, for example.

In some embodiments, the application at the communication device 106 may be a first application, and a second application may be identified as substantially similar to the first application. In these and other embodiments, the processor 204 may be further configured to present the setting recommendation to the user 103 of the communication device 106 to apply during use of the second application and may receive data indicating a response to the setting recommendation.

For example, the e-book application at the communication device 106 may be a first application, and a second e-book application may be identified as substantially similar to the first e-book application. The processor 204 may present the brightness setting recommendation to the user 103 of the communication device 106 to apply during use of the second e-book application. The processor 204 may receive a response to the brightness setting recommendation. The data indicating a response to the setting recommendation may be used by the processor 204 to confirm or adjust the pattern in relation to the second e-book application.

Alternately or additionally, the second application may be identified as substantially similar by comparing attributes of the first application to attributes of which are the second application to identify any shared attributes. The attributes may include one or more of: type of content available on the first or second application, functional capabilities of the first or second application, or settings available on the first or second application, or the like or any combination thereof.

For example, the second e-book application may be identified as substantially similar by comparing attributes of the first e-book application to attributes of the second e-book application to identify any shared attributes. The attributes may include similar e-book content available on the first and second e-book application, for example.

Accordingly, embodiments described herein contemplate determining setting recommendations of settings to apply at the communication device 106. The settings recommendations may be determined locally at the communication device 106 and/or remotely at the cloud computing system 102.

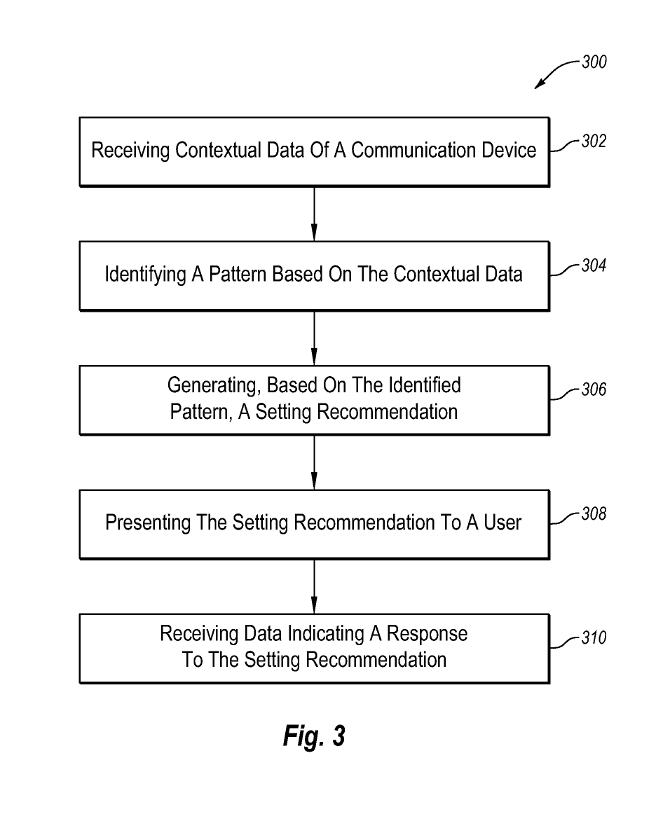

FIG. 3 is a flowchart of an example method 300 to effect setting recommendations at a communication device, arranged in accordance with at least some embodiments described herein. In some embodiments, the method 300 may be performed in whole or in part by a cloud computing system, such as the cloud computing system 102 of FIG. 1. Alternately or additionally, the method 300 may be performed in whole or in part by a communication device, such as the communication device 106 of FIG. 1.

The method 300 may begin at block 302 in which contextual data of a communication device is received. The contextual data may be received by, e.g., the data collection unit 216 of the communication device 106, or by the communication interface 118 of the cloud computing system 102. As already explained herein, the contextual data may indicate conditions existing at application of a setting during use of an application at the communication device.

The method 300 may continue at block 304 in which a pattern is identified based on the contextual data.

The method 300 may continue at block 306 in which a setting recommendation based on the identified pattern is generated. The setting recommendation may specify a setting to apply during use of the application at the communication device under conditions substantially matching the identified pattern.

The method 300 may continue at block 308 in which the setting recommendation is presented to a user, such as the user 103 in FIG. 1.

The method 300 may continue at block 310 in which data indicating a response to the setting recommendation is received.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, in embodiments in which the method 300 is performed by a cloud computing system, such as the cloud computing system 102 of FIG. 1, block 308 may not be performed by the cloud computing system. Rather, the cloud computing system may provide the setting recommendation to the communication device for presentation to the user by the communication device.

As another example, the method 300 may further include receiving data indicating a response to the setting recommendation. The method 300 may further include confirming or adjusting the identified pattern, based on the data indicating a response, in relation to the application.

Alternately or additionally, the application at the communication device in method 300 may be a first application and the method 300 may further comprise identifying a second application as substantially similar to the first application. The method 300 may further include presenting the setting recommendation to the user of the communication device to apply during use of the second application. The method 300 may further include receiving data indicating a response to the setting recommendation.

Alternately or additionally, identifying the second application as substantially similar to the first application may include comparing attributes of the first application with attributes of the second application to identify any shared attributes. The attributes may include one or more of: type of content available on the first and second application, functional capabilities of the first and second application, and settings available on the first and second application.

Alternately or additionally, the communication device may be a first communication device. In these and other embodiments, the method 300 may further include identifying a second application located on a second communication device associated with a user of the first communication device. The method 300 may further include presenting the setting recommendation to the user of the second communication device to apply at the second communication device during use of the second application. The method 300 may further include receiving data indicating a response to the setting recommendation. The second application on the second communication device may be the same as or different than the first application on the first communication device.

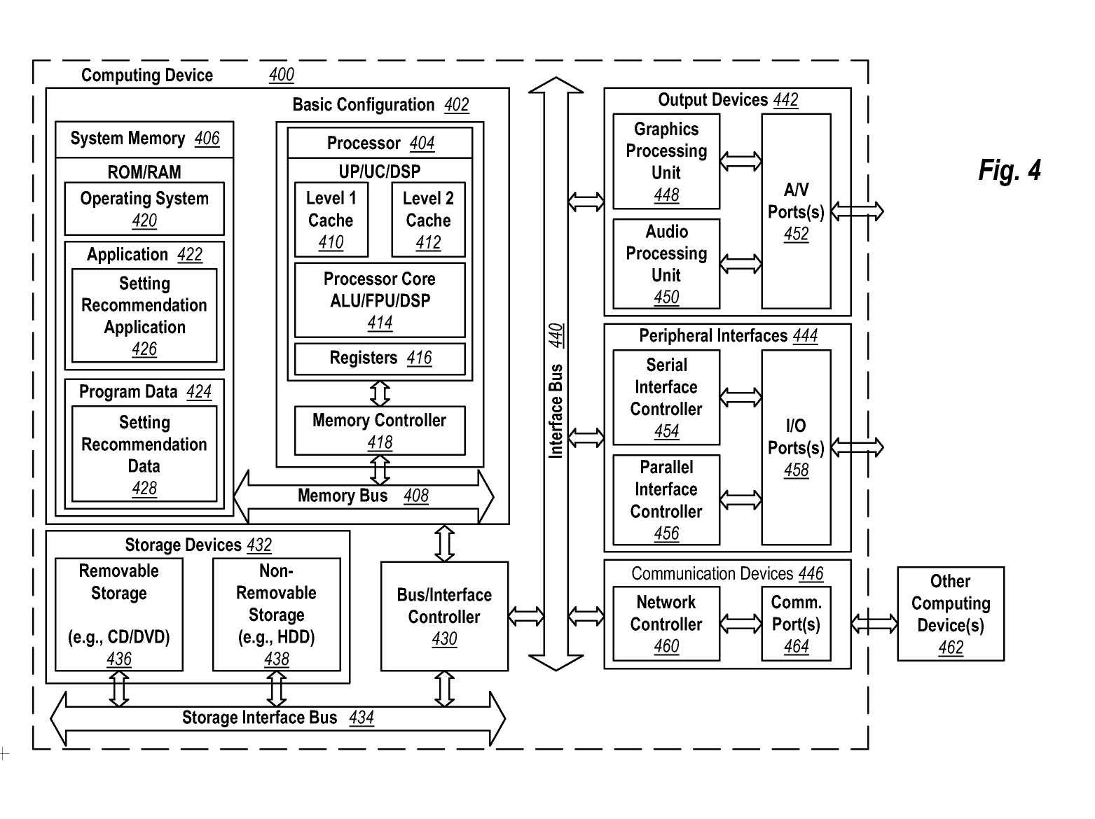

FIG. 4 is a is a block diagram illustrating an example computing device 400 that is arranged for effecting setting recommendations during use of an application at a communication device, arranged in accordance with at least some embodiments described herein. The computing device 400 may correspond to one or more of the communication devices 106, 107, 108 or servers 112 of FIG. 1, for example. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include a setting recommendation application 426 that is arranged to cooperate with other components of the communication device 106 or the cloud computing system 102 to effect setting recommendations according to the embodiments discussed above. Program data 424 may include setting recommendation data 428 that may be useful for effecting setting recommendations to one or more communication devices 106, 107, 108 as is described above. For example, the setting recommendation data 428 may include one or more settings, including default settings and/or user-applied or manual settings generated as described herein, and/or contextual data of a communication device used to identify patterns. In some embodiments, application 422 may be arranged to operate with program data 424 on operating system 420 such that implementations of setting recommendations may be provided as described herein.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a communication device, such as the communication device 106 in FIG. 1. The communication device 106 may be a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a portion of a cloud computing system, such as the cloud computing system 102 in FIG. 1.

All examples and conditional language recited herein are intended for pedagogical objects to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although embodiments of the present inventions have been described in detail, it should be understood that the various changes, substitutions, and alterations could be made hereto without departing from the spirit and scope of the invention.

What is claimed is:

1. A communication device, comprising:
a data collection unit configured to receive contextual data of the communication device, the contextual data indicating conditions existing at application of a setting during use of an application at the communication device; and
a processing device configured to:
identify a pattern based on the contextual data;
generate, based on the identified pattern, a setting recommendation of a setting to apply during use of the application at the communication device under conditions substantially matching the identified pattern;
present the setting recommendation to a user of the communication device; and
receive data indicating a response to the setting recommendation.

2. The communication device of claim 1, wherein contextual data comprises:
sensor data indicating conditions existing at application of the setting; and
usage data identifying the application in use during application of the setting.

3. The communication device of claim 2, further comprising one or more sensors configured to collect the sensor data, wherein the one or more sensors comprise at least one of:
a photovoltaic sensor;
an auditory sensor;
a location sensor;
a proximity sensor;
an accelerometer; and
a clock.

4. The communication device of claim 1, wherein the processing device is further configured to confirm or adjust the identified pattern, based on the data indicating a response, in relation to the application.

5. The communication device of claim 1, wherein:
the application at the communication device is a first application;
a second application is identified as substantially similar to the first application; and
the processing device is further configured to present the setting recommendation to the user of the communication device to apply during use of the second application.

6. The communication device of claim 5, wherein the second application is identified as substantially similar by comparing attributes of the first application to attributes of the second application to identify any shared attributes, the attributes comprising one or more of:
type of content available on the first or second application;
functional capabilities of the first or second application; or
settings available on the first or second application.

7. A cloud computing system, comprising:
a communication interface configured to receive contextual data from a communication device external to the cloud computing system, the contextual data indicating conditions existing at application of a setting during use of an application at the communication device;
a storage device configured to store the contextual data; and
a processing device configured to:
identify a pattern based on the contextual data;
generate, based on the identified pattern, a setting recommendation of a setting to apply during use of the application at the communication device under conditions substantially matching the identified pattern; and
provide the setting recommendation to the communication interface;
wherein the communication interface is further configured to:
provide the setting recommendation to the communication device for presentation to a user of the communication device; and
receive, from the communication device, data indicating a response to the setting recommendation.

8. The cloud computing system of claim 7, wherein contextual data comprises:
sensor data indicating conditions existing at application of the setting; and
usage data identifying the application in use during application of the setting.

9. The cloud computing system of claim 7, wherein the processing device is further configured to confirm or adjust the identified pattern, based on the data indicating a response, in relation to the application.

10. The cloud computing system of claim 7, wherein:
the application at the communication device is a first application;
a second application is identified as substantially similar to the first application; and
the processing device is further configured to provide, via the communication interface, the setting recommendation to the communication device for presentation to the user of the communication device to apply during use of the second application.

11. The cloud computing system of claim 10, wherein the second application is identified as substantially similar by comparing attributes of the first application to attributes of the second application to identify any shared attributes, the attributes comprising one or more of:
type of content available on the first or second application;
functional capabilities of the first or second application; or
settings available on the first or second application.

12. The cloud computing system of claim 7, wherein:
the communication device is a first communication device;
the application at the first communication device is a first application;
a second application is identified as substantially similar to the first application;
the second application is located on a second communication device; and
the processing device is further configured to provide, via the communication interface, the setting recommendation to the second communication device for presentation to the user of the second communication device to apply during use of the second application.

13. A method to generate setting recommendations, comprising:
receiving contextual data of a communication device, the contextual data indicating conditions existing at application of a setting during use of an application at the communication device;
identifying a pattern based on the contextual data;
generating, based on the identified pattern, a setting recommendation of a setting to apply during use of the application at the communication device under conditions substantially matching the identified pattern; and
receiving data indicating a response to presentation of the setting recommendation to a user of the communication device.

14. The method of claim 13, further comprising confirming or adjusting the identified pattern, based on the data indicating a response, in relation to the application.

15. The method of claim 13, wherein the application at the communication device is a first application, the method further comprising:
identifying a second application as substantially similar to the first application; and
presenting the setting recommendation to the user of the communication device to apply during use of the second application.

16. The method of claim 15, wherein identifying the second application as substantially similar to the first application includes:
comparing attributes of the first application to attributes of the second application to identify any shared attributes, the attributes comprising one or more of:
type of content available on the first or second application;
functional capabilities of the first or second application; or
settings available on the first or second application.

17. The method of claim 13, wherein the communication device is a first communication device and the application at the first communication device is a first application, the method further comprising;
identifying a second application on a second communication device associated with a user of the first communication device as being substantially similar to the first application; and
presenting the setting recommendation to the user of the second communication device to apply at the second communication device during use of the second application.

18. The method of claim 13, further comprising, prior to receiving the data indicating the response, presenting, by the communication device, the setting recommendation to the user.

19. The method of claim 13, further comprising, prior to receiving the data indicating the response, providing, from a cloud computing system, the setting recommendation to the communication device for presentation to the user.

20. A computer-readable storage medium having computer-executable instructions stored thereon that are executable by a processing device to perform the method of claim 13.
